(19) United States
(12) Patent Application Publication
(10) Pub. No.: US 2024/0154380 A1
(43) Pub. Date: May 9, 2024

(54) SAFETY LASER, PROTECTION METHOD AND MOBILE AUTONOMOUS ROBOT

(71) Applicant: IFOLLOW, Arcueil (FR)

(72) Inventors: Nicolas MENIGOZ, Paris (FR); Vincent JACQUEMART, Meudon (FR)

(21) Appl. No.: 18/550,461

(22) PCT Filed: Mar. 18, 2022
(86) PCT No.: PCT/EP2022/057186

§ 371 Date: Sep. 14, 2023

(30) Foreign Application Priority Data
Mar. 18, 2021 (FR) 2102734

(51) Int. Cl. H01S 3/04; G01S 7/481; G02B 1/18

(52) U.S. Cl. CPC H01S 3/04; G01S 7/4811; G02B 1/18

(57) ABSTRACT

The present technique proposes a safety laser (10) intended to move in environments at different temperatures, said safety laser (10) comprising laser emission means and at least one optical element (101), and comprising means for protecting said at least one optical element (101) comprising means (102) for regulating the temperature internal to said safety laser (10), means (103) for making said safety laser (10) airtight and means (104) for regulating the moisture level internal to said safety laser (10) to protect said at least one optical element (101).

### FIELD OF THE INVENTION

The field of the invention is that of logistics, in particular for order picking in a warehouse storing products to be dispatched.

The present invention relates in particular to improving the performances of robots moving in cold rooms alongside order pickers, and more particularly mobile autonomous robots.

### PRIOR ART

The logistics field has developed continuously for many years. With regard to order picking in particular, technical and technological changes have been numerous, ranging from management software to product conveyors passing through smart storage racks. Our concern here is more particularly with robots, and especially mobile autonomous robots, moving in particular in/between environments or zones the temperatures of which are different, or even very different.

Thus, when such a robot is used for order picking, it has to move between zones at ambient temperature (example for storing dry products), at temperatures between 1.5° C. and 5° C. (for example for storing chilled products), and at temperatures between −18° C. and −40° C. (storing frozen products), in the course of the order picking.

However, these changes in temperature may damage the robots and thus cause malfunctions that may interfere with the quality of the order picking. In addition, since these robots have a relatively high cost because of their great technical nature, replacing them because of degradation due to the conditions of use represents a significant drawback that is unacceptable for the industrialists who purchase them with a view to improving their logistic performances.

There is therefore a need for providing a novel approach that can enable a robot to move effectively between zones at different temperatures (in particular in a cold room) and not to suffer damage that may cause malfunctions, in particular when it changes zone and temperature, while optimising the costs of manufacturing and maintaining such robots.

### SUMMARY OF THE INVENTION

The present invention proposes a technical solution for protecting a safety laser, comprising laser emission means and at least one optical element, and intended to move in environments at different temperatures. To do this, the safety laser comprises means for protecting said at least one optical element comprising means for regulating its internal temperature, airtightness means and means for regulating its internal moisture level to protect the optical element.

Thus the present technique proposes a novel and inventive solution for protecting a safety laser against malfunctions due to changes in temperatures, based on the protection of its optical element so as to maintain it in an optimum operating state when the safety laser moves in environments at different temperatures.

This is because frequent changes in temperature may damage the safety laser since some of its components are not adapted thereto. However, this may cause malfunctions greatly impacting on the use of the safety laser, for example when it is incorporated in a mobile autonomous robot for picking orders. Such an application supposes in fact great variations in temperature between an environment at ambient temperature and a very highly refrigerated environment for example.

To protect the safety laser, the temperature and the humidity in the safety laser are regulated and the airtightness of the safety laser is optimised, so as to prevent in particular the appearance of condensation or mist on the optical element, an element essential to the operation of the safety laser.

According to a particular aspect of the present technique, the means for regulating the internal temperature comprise a first heating element attached via heat-conductive attaching means to a first surface of the safety laser.

Thus the safety laser comprises means for regulating its internal temperature in the form of a heating system consisting of a heating element, for example a patch, attached to one of the surfaces of the safety laser, for example the bottom surface, via heat-conductive attachment means such as aluminium Scotch tape. An external thermal insulator, of the foam type or equivalent, can also envelop the assembly consisting of the safety laser and the heating system in order to avoid any unnecessary loss of heat.

According to a particular feature, the means for regulating the internal temperature further comprise a second heating element attached via heat-conductive attaching means to a second surface of the safety laser.

According to this embodiment, the means for regulating the temperature internal to the safety laser comprise a second heating element attached to another of the surfaces of the safety laser, for example the top surface. The same heat-conductive attaching means can be used, as well as the foam for avoiding heat losses.

According to a particular aspect, the safety laser comprises means for controlling the means for regulating the internal temperature.

According to this embodiment, the means for regulating the temperature internal to the safety laser are controlled so as to be triggered when it is necessary to prevent the temperature internal to the safety laser from falling below a predetermined threshold. For example, these control means are a temperature sensor triggering the heating patches when the measure temperature corresponds to another predetermined threshold.

According to a particular feature, the airtightness means comprise a seal applied around the optical element. According to this embodiment, the safety laser comprises a seal around the optical element, i.e. between the optical element and the other components of the safety laser. This seal improves the airtightness of the safety laser in order to limit any contamination of the latter by the intrusion of water in the vapour state, liable to change state and therefore condense, for example when the safety laser moves into an environment at a lower temperature. This is because such condensation may lead to a malfunctioning of the safety laser. For example, this seal corresponds to an epoxy seal positioned between the lens of the safety laser and the frame of the latter.

According to a particular aspect, the protection means comprise anti-mist means comprising a specific anti-mist treatment applied to the optical element in the form of at least one layer of a first solution.

According to this embodiment, a first solution of an anti-mist treatment is applied to the optical element (inside and/or outside the optical glass), according to a very specific operating method requiring for example in advance the preparation of the surface (for example by removing the varnish from the surface and then disinfecting it) and then fixing the first solution layer (for example by heating).

It should be noted that the definition of this operating method requires very great expertise in the operation of the safety laser so as not to damage it during the application of the first solution of this anti-mist treatment.

This first solution is for example a primer.

According to a particular feature, the specific anti-mist treatment furthermore comprises at least one layer of a second solution applied to at least a part of the layer of the first solution.

According to this embodiment, a second solution of the anti-mist treatment is applied, over the first layer, once the fixing thereof is assured. This layer of second solution is also fixed, for example by heating, according also to a very precise operating method. There again, the definition of this operating method requires very great expertise in the operation of the safety laser so as not to damage it during the application of the second solution of this anti-mist treatment.

This second solution is for example an antistatic product.

According to a particular aspect, the means for regulating the internal moisture level comprise at least one element composed of a desiccant material.

According to this embodiment, the safety laser also comprises patches and/or sachets composed of or filled with a desiccant material, such as for example silica beads, for absorbing the moisture that may form inside the safety laser because of the changes in temperature undergone.

The present technique also relates to a method for protecting a safety laser intended to move in environments at different temperatures, the laser comprising laser emission means and at least one optical element, the method comprising the following steps:
regulation of the temperature internal to the safety laser;
application of airtightness means;
regulation of moisture level internal to the safety laser;
application of anti-mist means delivering the protected optical element.

Thus the present technique proposes a novel and inventive method for protecting a safety laser against malfunctions due to changes in temperatures, comprising various steps making it possible in particular to maintain the optical element of the safety laser in an optimum operating state when the safety laser moves in environments at different temperatures.

To do this, steps of regulating the temperature of the moisture level inside this safety laser are implemented, triggered for example according to predetermined thresholds taking account of the temperature and humidity level detected, as well as the application of several airtightness and anti-mist means specific to various zones of the safety laser, and in particular the optical element thereof.

According to a particular aspect, the method further comprises a step of calibrating the protected optical element. According to this embodiment, the optical element is calibrated once the various protective steps have been implemented. This is because applying the airtightness and/or anti-mist means specifically to the optical element, such as for example an anti-mist treatment, modifies its operation and therefore requires particular calibration and adapted configuration of the management software of the safety laser.

In addition, tests and/or burn-in are also necessary, under extreme conditions previously identified as potentially problematic for the operation of the safety laser (for example in extreme cold), so as if necessary to refine the configuration and the calibration of the optical element.

For example, regulation of the internal temperature comprises the attachment, via heat-conductive attaching means, of a first heating element to a first surface of the safety laser.

According to a particular feature, the application of the airtightness means comprises a step of applying at least one seal around the optical element and the regulation of the moisture level internal to the safety laser comprises the fitting of at least one element composed of a desiccant material.

According to a particular feature, the application of the anti-mist means comprises the following steps:
application of at least one layer of a first solution of a specific anti-mist treatment on the interior and/or exterior surfaces of the optical element;
first heating of the optical element;
application of at least one layer of a second solution of a specific anti-mist treatment on the optical element;
second heating the optical element;

According to this embodiment, a step of applying an anti-mist treatment is implemented on the optical element of the safety laser.

To do this, a layer of a first solution, for example a primer, is applied to the surfaces concerned and this first layer is fixed by a first heating of the optical element in an oven, for a first period adapted to the solution applied (for example thirty minutes) at a first temperature also adapted to the solution applied (for example 120° C.).

A layer of a second solution, for example an antistatic product, is applied on top of all or part of the first layer, and this second layer is fixed by a second heating of the optical element in an oven, for a second period adapted to the solution applied (for example twenty minutes) at a second temperature also adapted to the solution applied (for example 130° C.).

A first step of preparing the interior and/or exterior surfaces to be treated can be implemented before the application of the first solution layer and a finishing step can be implemented on the treated surfaces, comprising for example the elimination of any roughness and bubbles that might have appeared on the treated surfaces following the application of the two solutions.

The present technique also relates to a mobile autonomous robot moving in a plurality of environments at different temperatures, comprising:
a safety laser as described previously;
a box comprising at least one electronic component and means for regulating the temperature internal to the box, comprising at least one fan;
at least one electric geared motor equipped with protection means comprising a grease withstanding extreme temperatures and means for regulating the temperature of the electric geared motor;
at least one heat-insulated lithium battery auto-regulated for temperature by at least one internal resistor.

The present technique therefore proposes a mobile autonomous robot protected in a novel and inventive manner against malfunctions due to changes in temperatures, based on the protection of its elements most sensitive to the effects of such changes in temperature.

This solution is particularly adapted to mobile autonomous robots intended for order picking and moving in environments the temperatures of which vary very greatly and very often during the order picking.

### LIST OF THE FIGURES

The proposed technique, as well as the various advantages that it presents, will be understood more easily in the light of the following description of several illustrative and non-limitative embodiments thereof, and from the appended drawings wherein:

FIG. 1 illustrates a safety laser according to the general principle of embodiment of the present technique;

FIG. 2 illustrates means for regulating the temperature internal to the safety laser according to an embodiment of the present technique;

FIG. 3 illustrates means for making the safety laser airtight according to an embodiment of the present technique;

FIG. 4 illustrates means for regulating the moisture level internal to the safety laser according to an embodiment of the present technique;

FIG. 5 illustrates the main steps of a method for protecting a safety laser according to the general principle of the present technique;

FIG. 6 illustrates sub-steps of applying anti-mist means of the method for protecting a safety laser of FIG. 5, according to an embodiment of the present technique;

FIG. 7a illustrates a profile view of an example of a mobile autonomous robot according to the general principle of the present technique;

FIG. 7b illustrates a plan view of an example of a mobile autonomous robot of FIG. 7a according to the general principle of the present technique;

### DETAILED DESCRIPTION OF THE INVENTION

The general principle of the technique proposed consists in protecting a safety laser, or Lidar (standing for “Light Detection And Ranging” or “Laser Imaging Detection And Ranging”), from the effects of changes in temperature that it is caused to undergo when it moves in/between environments at different temperatures.

This is because a safety laser, as its name indicates, fulfils a crucial safety function for the object in which it is incorporated, such as for example the detection of obstacles, the perception of the environment or location on a map. In this regard, a safety laser must therefore be protected optimally against all unexpected events liable to degrade all or part of its operation, thus making it unable to fulfil its safety function.

For example, such safety lasers are integrated in robots, drones, autonomous cars, etc., thus enabling them to move in an autonomous and safe manner, including in open environments, in which the robots, drones or autonomous cars etc. cohabit with other mobile devices and/or individuals.

However, this safety function of a safety laser requires optimum precision, which may be degraded, in particular by damage to its lens, or optical element, an element that is particularly sensitive to changes in temperature and to the effects of such changes, such as for example the appearance of condensation or mist.

Moreover, when such a safety laser is incorporated in a mobile autonomous robot intended to move in environments at different temperatures, in the context of order picking for example, other elements of the robot are also sensitive to the changes in temperature and to the effects of such changes, such as for example the appearance of condensation or mist or the deformation of some components. The present technique therefore also proposes specific protection solutions adapted to each element of the robot, such as the onboard electronic components, the electric geared motors, the lithium batteries, or the specialised cable clusters.

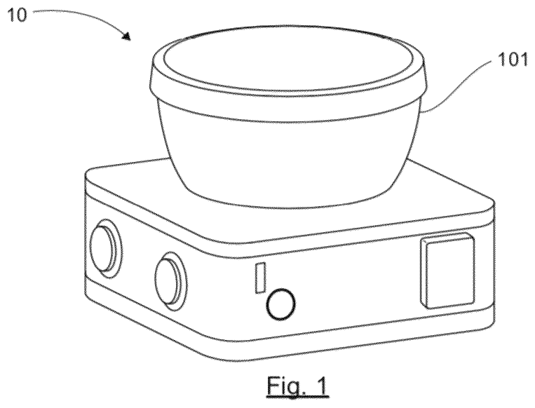

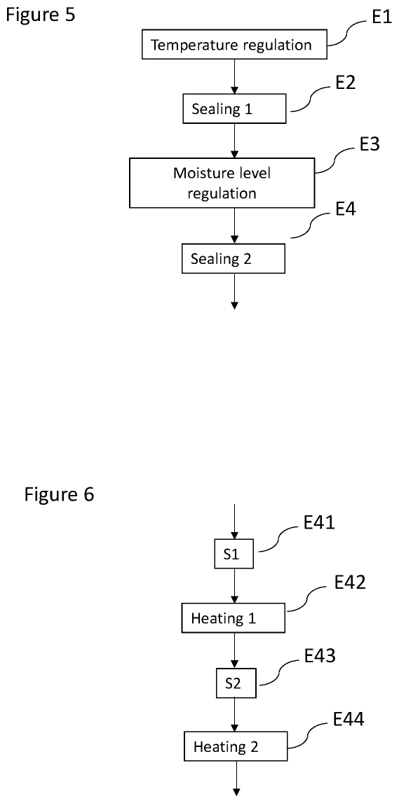

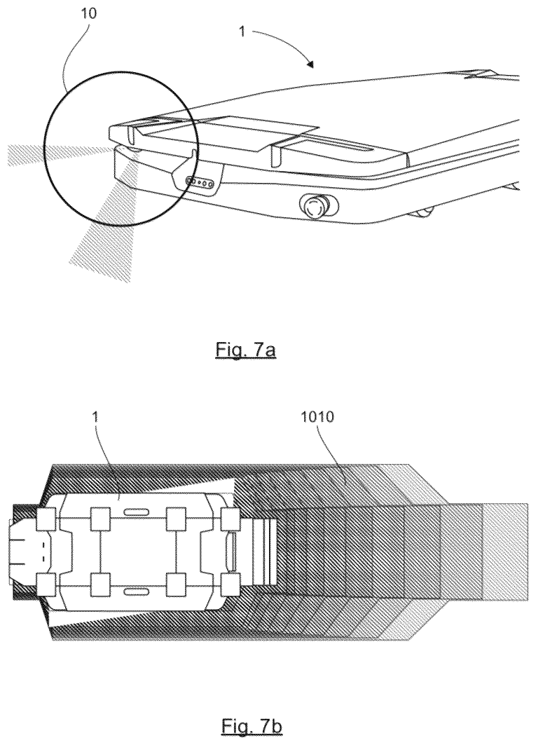

A description is first given, in relation to FIGS. 1 to 4, of the various means for protecting a safety laser proposed by the present technique, then, in relation to FIGS. 5 and 6, the main steps of a protection method for implementing these protection means, and finally, in relation to FIGS. 7a and 7b, the means for protecting other elements of a mobile autonomous robot.

FIG. 1 illustrates an example of a safety laser 10 having in particular an optical element 101, adapted to emit one or more laser beams and to receive one or more signals reflected by the object or objects located on the path of the laser. In a known manner, the reflected signals are collected and then transformed into electrical signals, and next processed by a chain for processing the signal to extract therefrom the information sought, such as for example the distance of the object on which the laser is reflected.

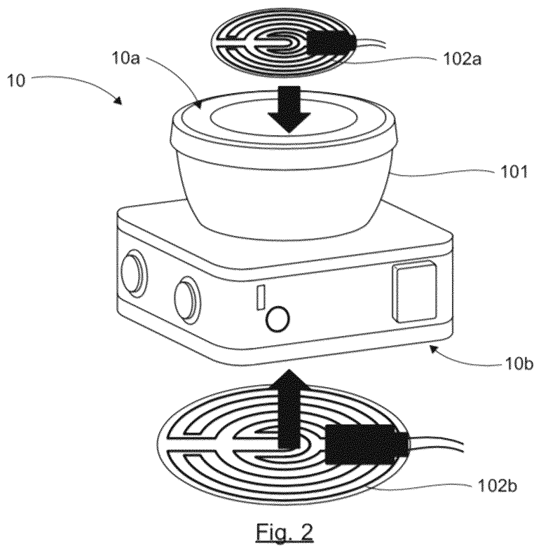

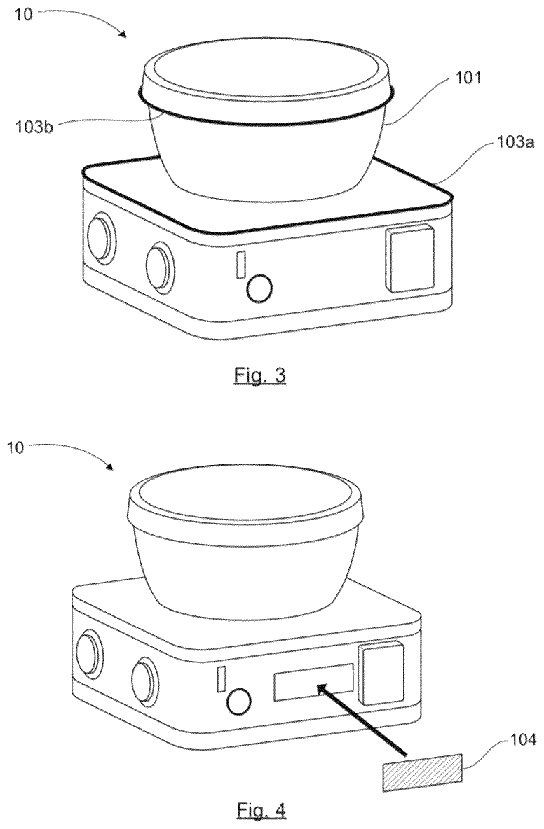

As indicated previously, this optical element constitutes one of the most important and most sensitive components of the safety laser. Thus the precision of the safety laser is assured to a major extent by the optimum quality of its optical element, under all circumstances of use, and in particular when the safety laser moves between environments at different temperatures. In order to overcome any malfunctions that might be caused by these changes in temperature, various means for protecting the safety laser, and in particular the optical element thereof, are implemented, according to the present technique, and in particular:
means 102 for regulating the internal temperature of the safety laser, described in relation to FIG. 2;
means 103 for making the safety laser airtight, described in relation to FIG. 3;
means 104 for regulating the moisture level internal to the safety laser, described in relation to FIG. 4.

The objective of its various protection means consists mainly in avoiding the appearance of condensation inside the safety laser. This is because any trace of mist or condensation on the optical element of the safety laser would have an immediate impact on its performances and its precision and would no longer enable it to fulfil its safety function. One solution might have consisted of continuously heating the interior of the laser, in order for example to maintain a constant temperature (for example of 25°), including when the safety laser moves in a refrigerated environment. The drawback of this solution lies in the known risk of deformation of certain elements of the laser because of heating, also causing a degradation of its performances.

Confronted with this technical problem, the inventors of the present application therefore found a technical solution optimally combining a plurality of protection means so as to be able to control, in real time, the moisture level and the temperature inside the laser, without negatively influencing its operation. The combination of the various solutions was the subject of a large number of calculations, tests and adjustments in order to obtain an optimum result while taking account of the various effects of these various solutions. Thus the various combined means make it possible to obtain a technical effect of regulating the temperature and the moisture level inside the safety laser, thus preventing any formation of mist or of condensation on its optical element.

To do this, protection means comprising in particular means for regulating the temperature and the moisture level, sealing means and anti-mist means can be combined while taking account of technical data, such as for example temperature, pressure and humidity values governing one or more thresholds below which the water vapour contained in the air condenses on the surfaces, by saturation effect.

The means 102 for regulating the internal temperature of the safety laser thus make it possible to control the temperature internal to the safety laser in a range of temperatures corresponding to the optimum operation of the safety laser, whatever the temperature external to the safety laser. To do this, as illustrated on FIG. 2, a first heating element 102a is attached, via heat-conductive attachment means, to a first surface 10a of the safety laser, for example the top external surface of the optical element 101. Such a heating element is for example a patch carrying heating elements, held for example by aluminium Scotch tape (heat conducting). According to the conditions of use envisaged for the safety laser, for example if it has to move in very cold environments, a second heating element 102b, for example of the same type as the first heating element 102a, is attached to a second surface 10b of the safety laser, for example the bottom external surface thereof.

These means 102 for regulating the internal temperature of the safety laser are furthermore controlled by control means (not illustrated) triggering them according to predetermined trigger thresholds. These trigger thresholds are in particular determined according to nomograms taking account of the conditions of use envisaged for the safety laser and the protection means used, and the control means take account of the temperature values supplied by one or more temperature sensors incorporated in the safety laser. In addition, the control means also take into account a frequency of switching the heating elements on and off, so as to not heat continuously, which could damage the safety laser, and so as to take account of a predetermined inertia (a “target” temperature is not obtained instantaneously but, if heating is carried out too much and/or for too long a time, it will be exceeded).

According to a variant, an external thermal insulator (for example a foam enveloping the safety laser and the temperature regulation means) is also provided for avoiding heat losses and thus for limiting the triggering of the heating elements.

Finally, the selection and the adjustment of the heating elements, as well as the triggering thereof, take into consideration the fragility and precision of the safety laser, according to its “manufacturer” technical characteristics, and the need not to degrade it, even to a minor extent.

As already indicated previously, the means 102 for regulating the internal temperature of the safety laser are judiciously combined with airtightness means 103 having the effect of limiting any intrusion of water vapour that could transform into condensation when the security laser moves towards an environment at a lower temperature.

According to an embodiment illustrated in FIG. 3, the airtightness means 103 comprise at least one seal 103a applied around the optical element 101, at its engagement with the frame of the safety laser. Another seal 103b can also be used at a junction of two parts of the optical element itself. For example, this or these seals are made from epoxy, or any other material having the adapted characteristics.

Knowledge of the performances of this or these seals 103a, 103b makes it possible in particular to parameterise the control means described previously, since these performances contribute to the control of the degree of moisture in the safety laser.

In addition, a hygrometry sensor (not illustrated) is provided in the safety laser in order to put it in a protected operating mode when the moisture level exceeds a predetermined threshold liable to greatly damage the safety laser. This protected operating mode comprises for example the emission of an alert in order, for example, for the device in which the safety laser is incorporated to be immobilised.

According to an embodiment that is not illustrated, the protection means comprise anti-mist means comprising a surface treatment by applying a hydrophobic film so as to avoid any risk of formation of condensation, in particular where the laser beam or beams pass. For example, this surface treatment is a specific anti-mist treatment applied to the optical element in the form of two layers of two distinct solutions having specific and distinct technical effects, which, when the two layers are combined, make it possible to obtain a supplementary technical effect: a primer layer and an antistatic treatment layer make it possible for example to obtain an optimum hydrophobic treatment.

Thus at least one layer of a first solution S1, for example a primer, is applied, according to various variants, over all or part of the interior surface of the optical element and/or over all or part of the exterior surface of the optical element, according to predetermined criteria dependent on the efficacy required, on the configuration of the optical element and on the application conditions specific to the first solution S1. Moreover, the application of this solution S1 conforms to a specific operating method, optionally and preferably commencing with steps of preparing the surface or surfaces to be treated, as will be detailed hereinafter, and providing a step of fixing the first solution layer applied. For example, this fixing step consists in heating the optical element, according to predefined duration and temperature parameters defined below.

In order to ensure optimum efficacy, at least one layer of a second solution S2, for example an antistatic product, is next applied to at least a part of the layer of the first solution S1.

There again, according to various variants, this second solution is applied over all or part of the interior surface of the optical element and/or over all or part of the exterior surface of the optical element, according to predetermined criteria dependent on the efficacy required, on the configuration of the optical element and on the application conditions specific to the second solution S2 and on the use of the prior application of the first solution S1. The application of this second solution S2 also conforms to a specific operating method providing a fixing step consisting for example in heating the optical element, according to predefined duration and temperature parameters defined below.

Preferably, and in order to optimise the performances of the anti-mist means, the anti-mist treatment or treatments are applied to the interior and exterior surfaces of the optical element. The result of this is better protection of the optical element so that optimum operation of the optical element is assured.

The inventors were confronted with great difficulties in implementing this anti-mist treatment since this type of treatment has never been applied to safety laser lenses, which are very fragile. Applying this anti-mist treatment, to the interior and exterior surfaces of the optical element, was therefore all the more difficult to develop and implement.

Thus the surface treatment selected had to be adapted to this fragility and to the precision of the laser, and the various steps of application thereof were defined specifically for these safety lasers, in particular to ensure that the surface through which the laser passes is always free from condensation and keeps optimum precision.

Finally, according to a first variant, the anti-mist means can be applied alone or, according to a second variant, in combination with the airtightness means 103, i.e. with the seal or seals 103a, 103b described above.

In combination with the anti-mist means, the means 102 for regulating the temperature and the airtightness means 103, the safety laser according to the present technique furthermore has means 104 for regulating the internal moisture level. For example, as illustrated on FIG. 4, at least one element 104 composed of a desiccant material (for example a sachet containing silicon beads) is inserted inside the safety laser, so as to absorb the moisture. A plurality of these elements 104 can be inserted in the safety laser, according to their size and the free spaces inside the safety laser in particular.

The main steps of a method for protecting a safety laser are now described in relation to FIG. 5. These main steps can be implemented in parallel in order to provide the combination of means used, as described previously.

Thus the protection method comprises a step E1 of regulating the temperature internal to the safety laser, consisting in particular in controlling heating elements positioned at strategic points inside the safety laser, as illustrated for example in FIG. 2 described above. This control of the heating elements takes account in particular of temperature sensors also disposed in the safety laser, but also of the step E2 of applying the airtightness means, consisting in using one or more seals, in particular between the optical element and the frame of the safety laser.

Likewise, step E1 of regulating the temperature internal to the safety laser takes account of a step E3 of regulating the moisture level internal to the safety laser, consisting for example in disposing in the safety laser one or more elements made from desiccant material.

Steps E2 and E3 are implemented for example when the safety laser is manufactured, whereas step E1 is implemented continuously during the use of the safety laser.

Moreover, a step E4 of applying anti-mist means is also implemented in order to deliver a protected optical element, i.e. modified specifically compared with a conventional optical element of a safety laser. This step E4 is implemented before the use of the safety laser, in a manufacturing phase specific to the present technique, and comprises in particular the following sub-steps:
application E41 of at least one layer of a first solution of a specific anti-mist treatment, for example a primer, on the interior and/or exterior surfaces of the optical element, and a first heating E42 demands the optical element in order to fix the first layer; the zones of application of this first solution (exterior and/or interior surface, all or part of this/these surfaces), the thickness of the layer and the parameters of the heating (for example 120° C. for thirty minutes) are determined by the technical and functional characteristics of this first solution as well as the fragility constraints of the lens of the safety laser;
application E43 of at least one layer of a second solution of a specific anti-mist treatment, for example an antistatic solution, on the optical element, and a second heating E44 of the optical element; there again, the zones of application of this second solution (exterior and/or interior surface, all or part of this/these surfaces), the thickness of the layer and the parameters of the heating (for example 130° C. for twenty minutes) are determined by the conditions of application of the first solution, the technical and functional characteristics of this second solution as well as the fragility constraints of the lens of the safety laser;

The sub-step E41 may be preceded by a sub-step of preparing the surfaces to be treated, such as for example the elimination of the varnish conventionally applied to a safety laser optical element, the grinding/cleaning of the surfaces to be treated, as well as the disinfection of these surfaces, for example with alcohol at 70° C.

Likewise, the sub-step E44 can be followed by a sub-step of finishing the treated surfaces, comprising for example the elimination of any roughness and bubbles that might have appeared on the treated surfaces following the application of the two solutions and the heatings.

Finally, since this step E4 of applying an anti-mist treatment on the optical element inevitably causes a few upsets, even minor, to the precision of the safety laser, it is useful to further implement a step of calibrating the optical element thus protected, so as to confer on it once again all these capabilities. To do this, tests are implemented under real conditions of use, for example in very highly refrigerated environments, as well as during a change between environments at different temperatures, and the control software of the safety laser is specifically configured for the optical element protected by the anti-mist treatment.

The various means and steps described above therefore make it possible, in combination and in interaction, to provide a safety laser protected against the risks of formation of condensation and mist when it moves within environments at different temperatures, while keeping its optimum performances in terms of precision in particular.

Such a protected safety laser is therefore entirely able to be incorporated for example in a mobile autonomous robot for order picking in various environments of storage of products to be taken for orders. FIGS. 7a and 7b illustrate an example of a mobile autonomous robot 1 having a safety laser 10, an example of a laser beam 1010 of which makes it possible to measure the efficacy and advantage thereof, in terms of safety of movement of the mobile autonomous robot 1. This is because the safety laser enables the mobile autonomous robot to have real-time knowledge of its environment, for example up to 170° around the robot, to detect any obstacles, according to the speed of the robot, and therefore to be able to safely cohabit with control operators or other robots.

Moreover, the performances of such a mobile autonomous robot can also be reinforced under such conditions of use by the protection of other elements of the robot, according to solutions found by the inventors of the present application.

Thus the electronic components installed in the robot are, as far as possible, stored in a box regulated for temperature by means of the heat given off by the embedded industrial computer. This is because the inventors have observed that all the installed electronics, including the computer, could self-regulate for temperature, with the help of one or more fans, for example of the type blocking the air when it turns in one direction and making air enter when it turns in the other direction. The electronic components installed in the robot are therefore also protected from any impacts of frequent changes in temperature of the environments in which the robot moves.

Moreover, the electric geared motors incorporated in the robot are equipped with a specific grease that can change between −60° C. and +40° C. as well as heating elements for limiting the deformations of certain parts due to the changes in temperature. This double protection makes it possible in particular to ensure the frictionless operation of parts able to move with respect to each other and thus the optimum operation of the geared motors.

Finally, the lithium batteries enabling the robot to operate with great autonomy of energy are manufactured to measure, thermally insulated and autoregulated for temperature through their internal resistor, thus enabling them to operate up to 16 hours in cold. These internal resistors are triggered according to temperature sensors and taking account of the fact that, the more battery is used, the more it heats up. Finally, safety devices are also used to deactivate a battery cell if the ambient temperature detected around the cell is negative.

Thus a mobile autonomous robot protected according to the various embodiments of the invention has optimum performances under extreme conditions of use, further improving the productivity of order picking using such robots, as well as the maintenance of these robots having reinforced robustness compared with the prior art.

1. Safety laser intended to move in environments at different temperatures, said safety laser comprising laser emission means and at least one optical element, characterised in that said safety laser comprises means for protecting said at least one optical element comprising means for regulating the temperature internal to said safety laser, means for making said safety laser airtight and means for regulating the moisture level internal to said safety laser to protect said at least one optical element.

2. Safety laser according to claim 1, characterised in that said means for regulating the internal temperature comprise a first heating element attached via heat-conductive attaching means to a first surface of said safety laser.

3. Safety laser according to claim 2, characterised in that said means for regulating the internal temperature further comprise a first heating element attached via heat-conductive attaching means to a second surface of said safety laser.

4. Safety laser according to claim 1, characterised in that it comprises means for controlling said means for regulating the internal temperature.

5. Safety laser according to claim 1, characterised in that said airtightness means comprise at least one seal applied around said optical element.

6. Safety laser according to claim 1, characterised in that said protection means comprise anti-mist means comprising a specific anti-mist treatment applied to the optical element in the form of at least one layer of a first solution.

7. Safety laser according to claim 6, characterised in that said specific anti-mist treatment furthermore comprises at least one layer of a second solution applied to at least a part of the layer of the said solution.

8. Safety laser according to claim 6, characterised in that said specific anti-mist treatment comprising said at least one layer of a first solution and at least one layer of a second solution is applied to an interior surface and an exterior surface of said optical element.

9. Safety laser according to claim 1, characterised in that said means for regulating the internal moisture level comprise at least one element composed of a desiccant material.

10. Method for protecting a safety laser intended to move in environments at different temperatures, said laser comprising laser emission means and at least one optical element, said method comprising the following steps:
regulation of the temperature internal to said safety laser;
application of airtightness means;
regulation of the moisture level internal to said safety laser;
application of anti-mist means delivering said protected optical element.

11. Method for protecting a safety laser according to claim 10, characterised in that it further comprises a step of calibrating said protected optical element.

12. Method for protecting a safety laser according to claim 10, characterised in that said regulation of the internal temperature comprises the attachment, via heat-conductive attaching means, of a first heating element to a first surface of said safety laser.

13. Method for protecting a safety laser according to claim 10, characterised in that said application of first means for protecting said at least one optical element comprises a step of applying at least one seal around said optical element.

14. Method for protecting a safety laser according to claim 10, characterised in that said regulation of the internal moisture level internal to said safety laser comprises the fitting of at least one element composed of a desiccant material.

15. Method for protecting a safety laser according to claim 10, characterised in that said application of second means for protecting said at least one optical element comprises the following steps:
application of at least one layer of a first solution of a specific anti-mist treatment on the interior and/or exterior surfaces of said optical element;
first heating of said optical element;
application of at least one layer of a second solution of a specific anti-mist treatment on said optical element;
second heating of said optical element.

16. Mobile autonomous robot moving in a plurality of environments at different temperatures, characterised in that it comprises:
a safety laser according to one of claim 1;
a box comprising at least one electronic component and means for regulating the temperature internal to said box, comprising at least one fan;
at least one electric geared motor equipped with protection means comprising a grease withstanding extreme temperatures and means for regulating the temperature of said electric geared motor;
at least one heat-insulated lithium battery auto-regulated for temperature by at least one internal resistor.
